(19) United States
(12) Patent Application Publication
(10) Pub. No.: US 2005/0211488 A1
(43) Pub. Date: Sep. 29, 2005

(54) Methods and devices to improve the electric and battery powered motorcycle

(76) Inventors: Francine J. Gore, Kutztown, PA (US); Gerald E. Gore, Kutztown, PA (US)

Correspondence Address: EZRA SUTTON, P.A.;PLAZA 9 BUILDING, SUITE 201, 900 ROUTE 9 NORTH, WOODBRIDGE, NJ, 07095, US

(21) Appl. No.: 10/811,462

(22) Filed: Mar. 26, 2004

(51) Int. Cl. B62M 7/00

(52) U.S. Cl. 180/219

(57) ABSTRACT

Apparatus for affixing batteries to a motorcycle for the production of electricity, which includes a battery or plurality of batteries sized to fit within the frame of a motorcycle; a motorcycle frame of sufficient size or diameter to fit and contain the batteries; and apparatus for connecting the batteries to the electric connection, bus or battery system of the motorcycle.

### FIELD OF THE INVENTION

This invention relates to the battery-powered motorcycle. It also relates to electric motorcycles and methods and devices to improve their performance and commercial acceptability.

### BACKGROUND OF THE INVENTION

This invention recognizes that motorcycles, especially gasoline fueled motorcycles have gained a renewed popularity. This renewed popularity can be witnessed by their growing numbers and their increased popularity with high profile individuals. There is also a growing acceptance of their riders in the United States.

This invention also recognizes that motorcycles, scooters and other two and three wheeled motorcycles are the foundation for the transportation systems in many other countries. Compared to the cost of an automobile, many scooters and motorcycles are much less expensive. Natural demand and manmade pressures such as the cost of gasoline should increase the number of all motorcycles. One might believe that with these pressures that battery powered motorcycles would growing rapidly and in large numbers. Yet many individuals are not purchasing electric motorcycles even in areas of extreme air pollution. Even pioneers and risk takers are abandoning the battery powered motorcycle . However, large numbers of drivers/riders have gone to large cruising motorcycles that are impressive in size, power and cost. Many popular models of Harley Davidson Motorcycles or Honda Motorcycles are an example of these large cruising motorcycles and they are not purchased primarily for their gas economy and they still add pollution to the air. However, the popularity of these motorcycles is due to much more than a cult mystic. In this day of rising cost of gasoline and the increasingly upward spiral of passenger vehicle and automobile costs one might wonder or believe that there would be even more of a market for these gasoline motorcycles to compete with the four wheeled gasoline automobile or passenger vehicles. This market is expanding especially when one looks abroad, especially in Asia. However, when we look at the United States and other highly developed and affluent countries, we need to understand the limitations of these motorcycles. Limitations include inclement weather of all forms including wind, snow, ice, rain and freezing rain. Other road hazards, are gravel, leaves, road conditions, road construction, debris and stop and go traffic.

An important restriction of the battery powered motorcycle and even the gasoline motorcycle is the limited number of riders that can be accommodated verses the number of occupants in most cars and passenger vehicles. Most gasoline powered motorcycles can accommodate a driver and a single rider depending on the rider's weight.

Additionally battery, electric, and gasoline powered motorcycles have to deal with the difficulty presented to their riders or drivers of being directly exposed to the elements much more than in a car. Even with windshields, windscreens and protective clothing, very little real protection is afforded the driver. This will be a similar difficulty also to be overcome by fuel cell, hybrid, and hybrid fuel cell motorcycles.

Gasoline motorcycles are gaining in popularity. Given the rising cost of gasoline, one might believe that electric motorcycles should achieve at least similar same level of success. But they are not, it is unfortunate but battery powered motorcycles are sharing the same dismal fate as electric battery powered vans and even cars such as General Motors EV1.

There are a small number of battery motorcycles. Some present a sporty presentation, even the very popular Ninja style. Yet these battery-powered motorcycles are not sharing the same success as their gasoline powered cousins. A number of manufactures and potential manufactures are abandoning the development and commercialization efforts for the electric motorcycle. Unfortunately, this negatively impacts fuel cell and hybrid electric motorcycles as well. The E-Cycle is an example of an electric battery motorcycle that was offered for sale and is no more. The charging requirement and the loss of use and not having the motorcycle available because of the time requirements of charging, limited range between charges, unavailable highway charging stations, restrictions on load, and restrictions on range were some of the negative factors of most battery or electric motorcycles.

A significant part of their difficulty and lack of acceptance by the general public was because of their lack of range, lack of payload carrying ability, relative small size and further reduction in power from the batteries in cold weather. All of which relate to power difficulties. The obvious solution to this difficulty is to increase the size and capacity of the batteries and or improve battery technologies. Adding more or larger batteries is the obvious solution but has not met with success or commercial viability due to added battery weight, cost, and battery related cold weather difficulties. In addition, where would the batteries go, because there is no room on the machine to add them.

An additional and major problem on these complex vehicles is their small size and no apparent open space or unused space to add more large motorcycle batteries. All components on motorcycles seem to be jammed into the machine. These parts and components are necessary, so there is really nothing the motorcycle designers and manufacturers can even remove. New components would need space for the component, and space for the housing of the component. Housings need to be sturdy since so much surface of the motorcycle is exposed directly to the elements, such as spray from other vehicles, salt, dirt and road hazards. New components would add weight for the component, and weight for the component housing. By being attached onto the motorcycle, a the component would be exposed to the elements and would also add more drag. This invention recognizes the shortcomings of the battery powered electric motorcycles and this invention develops modifications and improvements that will improve the commercial viability of these motorcycles and help to develop a new breed of motorcycle.

Battery technologies, new and emerging have been evaluated and offer incremental improvement to the battery-powered motorcycle and their manufacturers. This invention recognizes that there are many positive features related to electric powered motorcycles. But their load and range restrictions have also restricted their size. This invention addresses this major shortcoming of the battery-powered motorcycle—power shortage. Battery powered motorcycles are significantly smaller and lighter than their gasoline counterparts. Manufacturers have made vehicles that reflect their power availability or lack thereof and not addressed the needs or desires of its riders.

This invention proposes unique solutions to the electric motorcycle that will allow the battery motorcycle to be able to grow in size, range and power.

### SUMMARY OF THE DRAWINGS

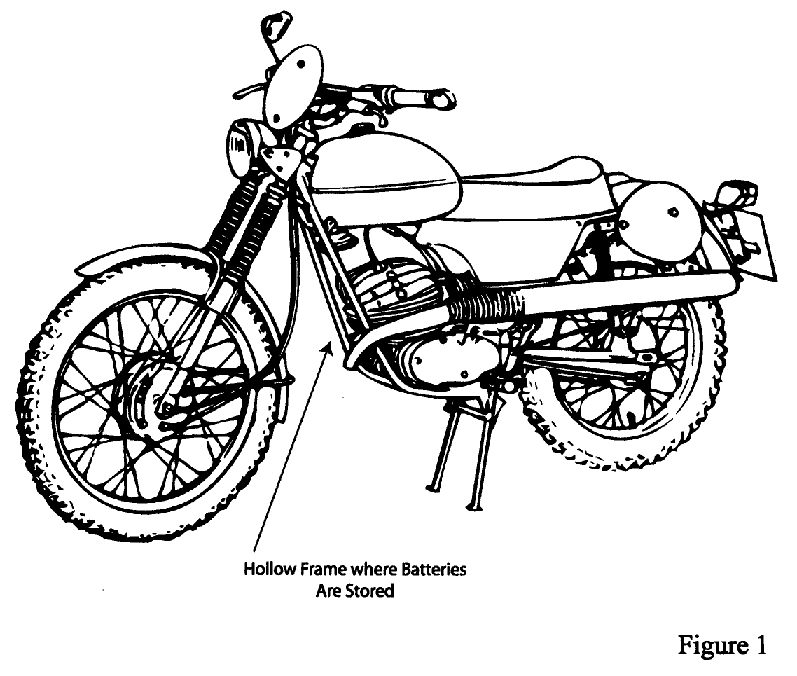

A. FIG. 1 shows a typical motorcycle that is facing left with emphasis the location of the motorcycle frame for battery storage.

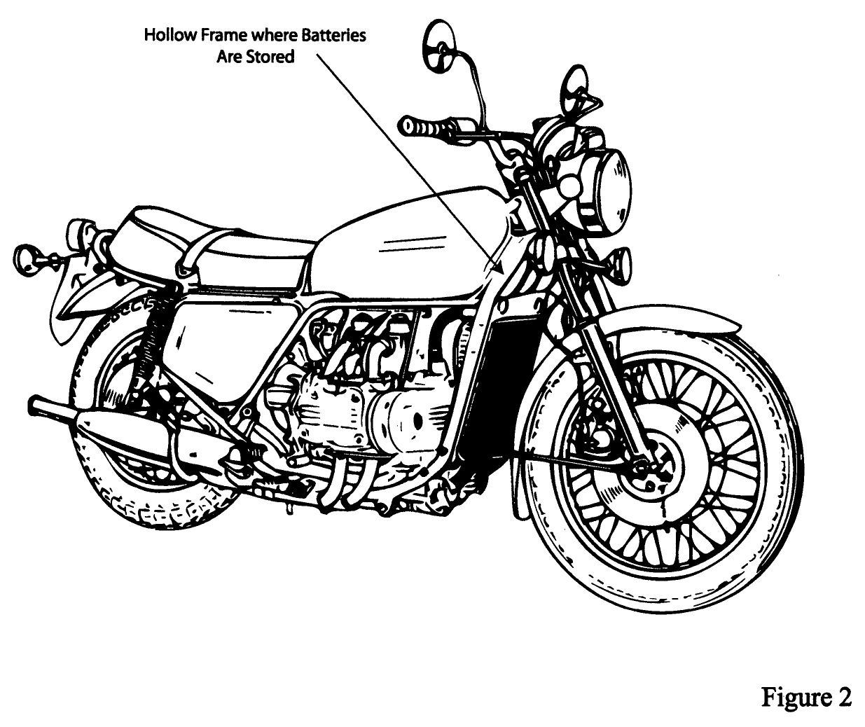

B. FIG. 2 shows a typical large motorcycle that is facing right and emphasis on the location of the motorcycle frame for battery storage.

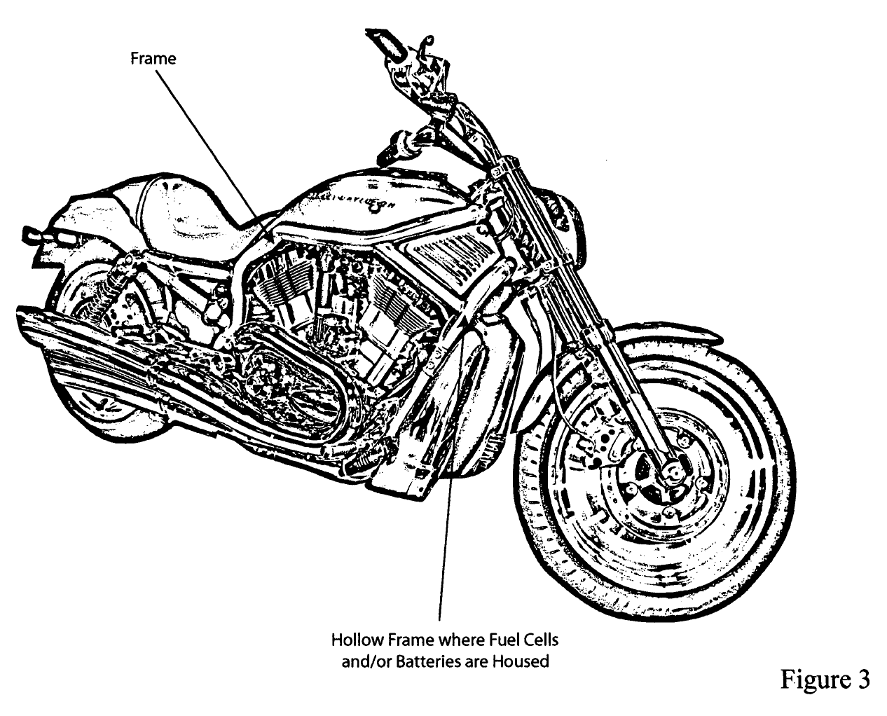

C. FIG. 3 shows a large, new powerful motorcycle that is facing right. The motorcycle is a Harley Davidson Vrod. The extensive frame of this motorcycle is emphasized. Noted as applicable to fuel cell and or batteries.

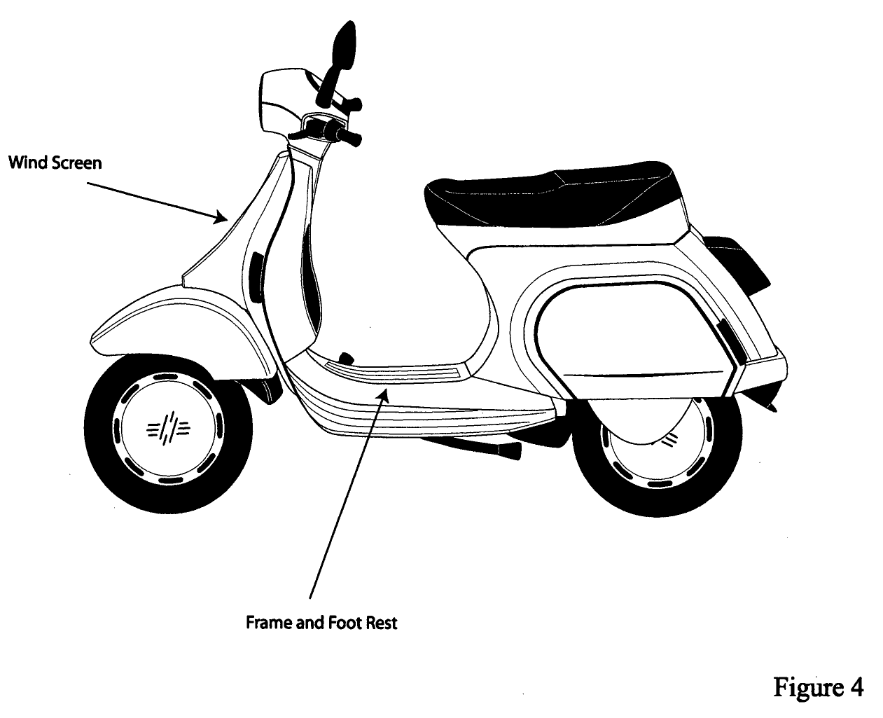

D. FIG. 4 shows a typical motor scooter that is facing left. The motor scooter windscreen and lower frame and footrest are indicated.

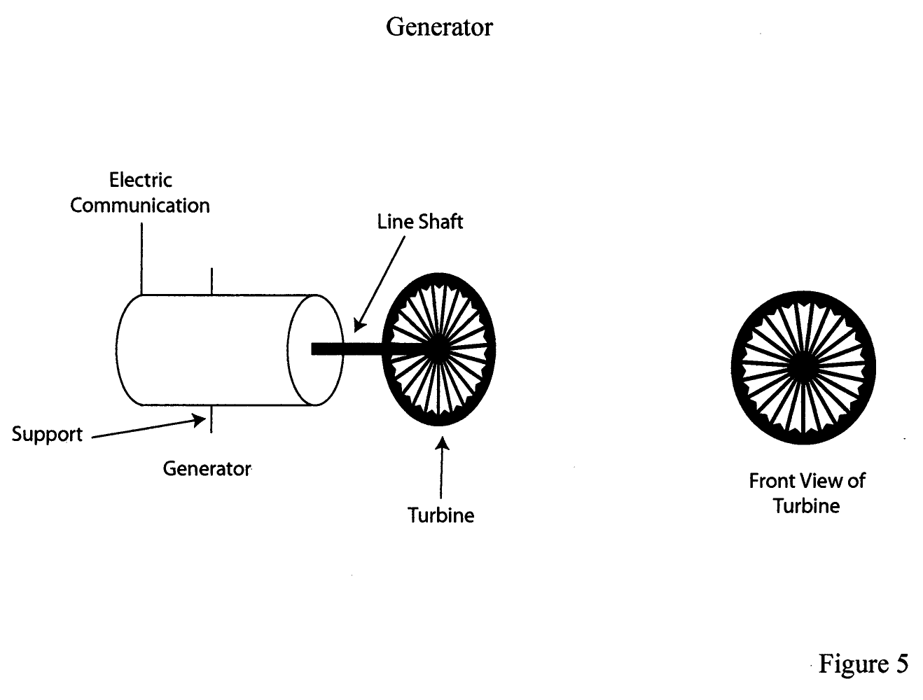

E. FIG. 5 shows a style of generator with shaft and turbine also with supports for the mounting of the generator and means for electric connection and or communications.

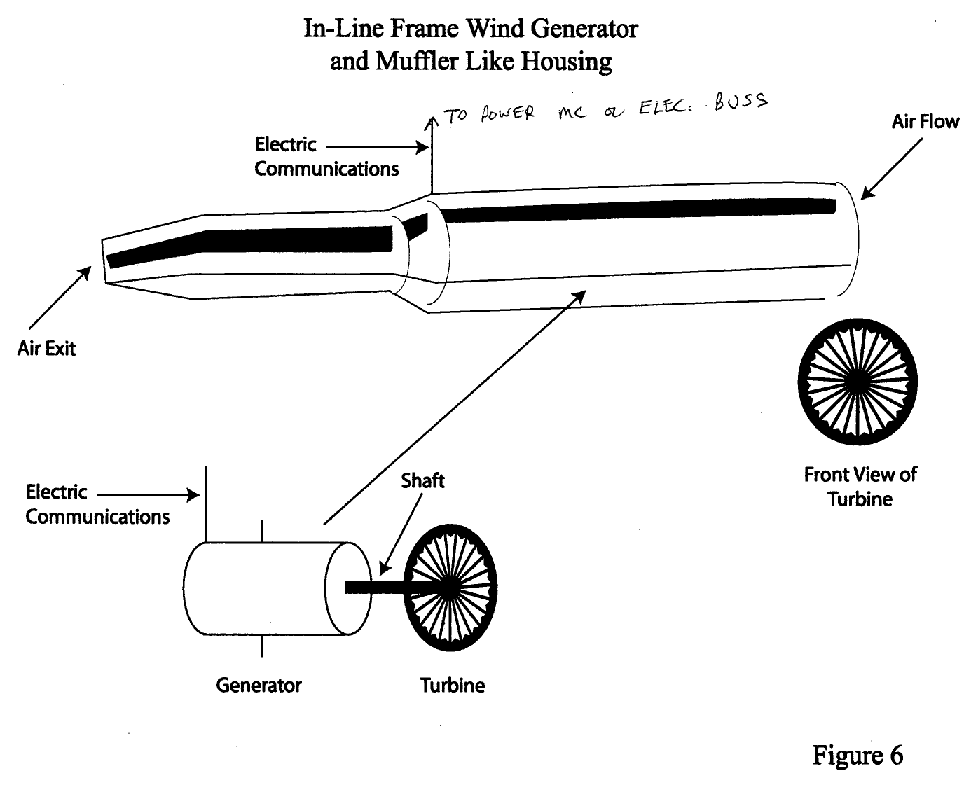

F. FIG. 6 shows a frame wind generator system of FIG. 5 and a device resembling a muffler that is open at both ends.

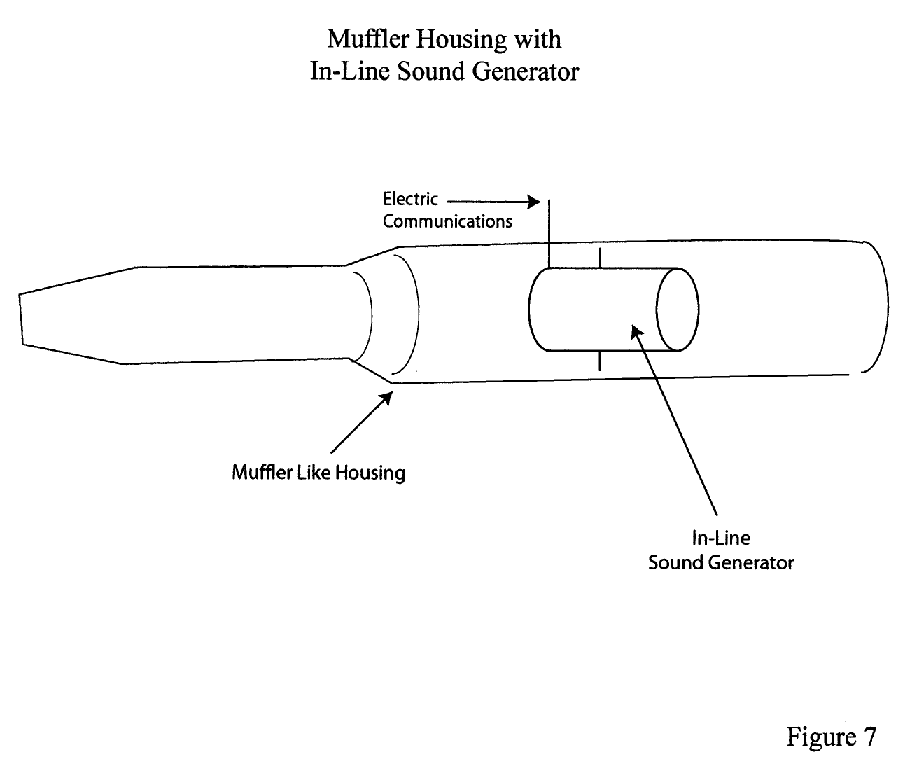

G. FIG. 7 shows a muffler like device that can be housing for a sound system and the muffle like device can transfer generated sounds.

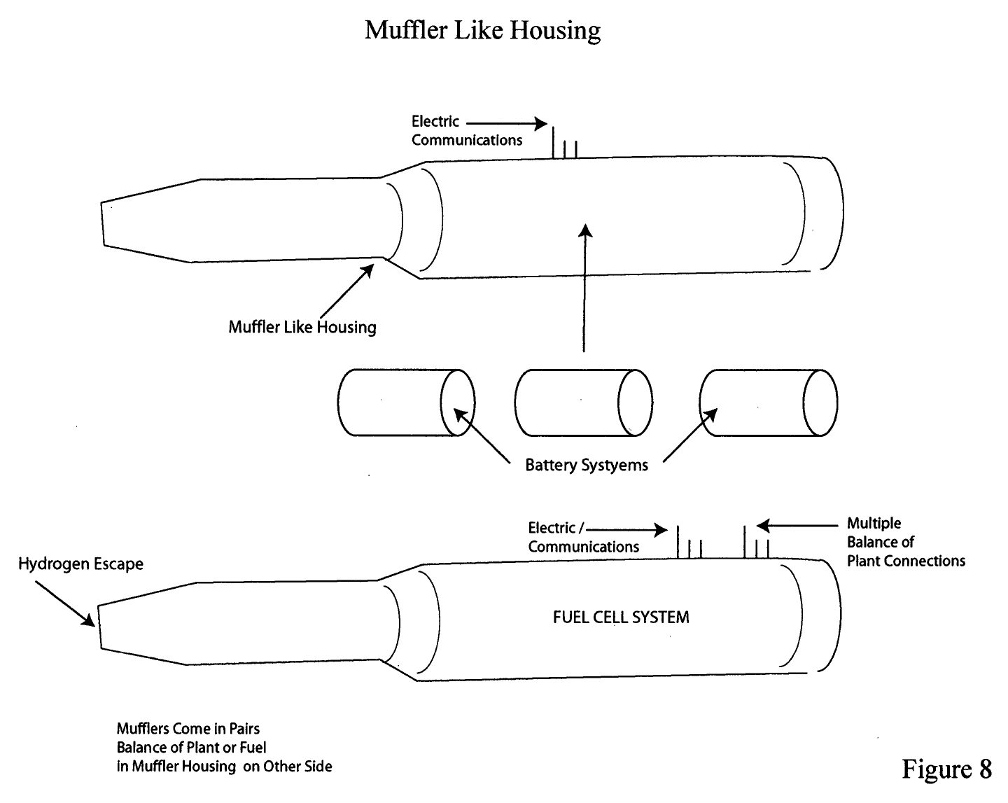

H. FIG. 8 shows a muffler like device that is housing for fuel cells and a device for batteries. The device can house multiple units and multiple technologies. Fuel cells and sound are an example.

### SUMMARY OF THE INVENTION

This invention provides unique and novel methods, apparatus and processes for the dual use of components of motorcycles and motor scooters. This invention utilizes the vehicle frame as housing. The frame housing can be used for batteries and other technologies. This invention further recognizes that by utilizing the frame, a housing is developed that adds little or no additional cost to the vehicle. This invention further incorporates that as a dual use component the frame as housing also adds little or no additional weight. This invention further recognizes and incorporates that utilizing the frame as housing uniquely affords the contents with significant structural protection not afforded in some typical housings. In fact, the frame is one of the strongest components of the motorcycle.

This invention uniquely provides that use of the frame as housing provides a significant improvement to the electric motorcycle by utilizing formerly unused space for additional batteries, fuel cells or other systems or technologies. The use of this invention, and this additional space is translated to additional power that is now available to the electric motorcycle. This invention and its use will improve range and/or increase load capability of these vehicles. Pliable batteries and certain fuels can be contained in straight or curved frame components. This invention will take advantage of straight frame for components for certain systems, and will direct certain components and designers to utilize more straight frame components. This invention will add flexibility to increase the size of the machine and also improve flexibility of design. This will allow for more customer desired models, more customer acceptance and improve the commercial potential of these machines.

A major enemy of any vehicle is weight. This is believed by many to be one of the single largest enemy of the battery or electric motorcycle and specifically because of lack of power or electrical capacity. This invention focuses on creating unique dual functionality of certain components of the motorcycle. Many motorcycles are constructed with tubular frames. This invention uniquely incorporates and uses and in certain cases modifies these tubular frames so that the frame itself can also double as housing. The frame can be the housing for the mounting or inserting of batteries. This invention also incorporates that even gasoline motorcycles benefit from this invention and gain additional space for batteries or fuel cells or other system to provide electricity for the ever-increasing housekeeping electrical load of these machines.

This invention provides that the frame is modified in diameter and shape to accommodate current and evolving battery designs and other technologies. These frames uniquely provide housing and mounting for fuel cells and fuel cell stacks. Fuel cells may be one of the tools of salvation for the electric motorcycle or scooter. Most fuel cells are depicted as large, square or rectangular structures. This invention recognizes that fuel cell stacks need not always be large and square or rectangular but are a stack of individual cells that can be manufactured to differing shapes and sizes. This is especially the case for Proton Exchange Membrane (PEM) fuel cells. This invention incorporates that the frame holds hydrogen, hydrogen storage materials, for fuel cells, fuel cell hybrid or hydrogen fueled vehicles.

Not all motorcycles and scooters have tubular frames. This invention incorporates that other frame types and the wind screen in scooters can also be used for the dual purpose of housing of batteries or other technologies. The front frame of the scooter as an example, functions as a short wind screen. This invention incorporates the screen, and modifies it to also accommodate battery systems such as lithium batteries. The windscreen of the Vespa Motor scooter is an example of a candidate for modification by this invention. Batteries or fuel cells are affixed to the wind screen and covered by a metal, plastic or other material cover. The batteries are affixed to either side of the wind screen but the driver side would be most desired. Wiring could easily connect the batteries to the electric bus of the scooter. This invention is not limited to battery vehicles but is applicable for numerous motor cycle types is applicable to hybrid internal combustion, hybrid fuel cell and fuel cell powered motorcycles. This invention incorporates that electric lines, communication lines, fuel lines and others extend from the frame to other components on the motorcycle as necessary. The lines can be from the component to the frame and from the component to other areas as needed.

To fully practice the invention and to demonstrate its flexibility and additional applications, this invention and its claims are extended to other motorcycle components. These components like the frame are product housings and are the following: frame, handlebars, engine protectors, shock absorbers, saddlebags, and muffler like devices. A frame wind generator system can be housed totally within the frame with the frame also acting as the wind director for the turbine. The wind generator system can also be mounted within the frame with the turbine or turning component interior or exterior to the frame. The wind generator can also be included in the exhaust using the exhaust for wind.

The present invention uniquely recognizes the ability of modifying existing components of the motorcycle to accommodate new uses and new systems.

### Preferred Embodiment of the Invention

In the text that follows below, the preferred embodiments are represented in a number of diagrams and a discussion of a variety of components of motorcycles and motor scooters. These components have a traditional use and an additional unobvious use. The additional use or uses for that same or slightly modified component allows it to have multiple uses. These multiple use components or multi-components are appropriate for a number of new applications and or new technologies.

FIG. 1, shows a diagram of a typical motorcycle facing left and especially emphasizing the frame of the motorcycle. The diagram of the motorcycle presents a side view of the motorcycle. It is important to note that the frame is hollow.

This diagram shows one side of the motorcycle. It is important to note that the frame is equally expansive on the other side of the motorcycle as well. This speaks of a significant amount of unused space and a housing structure available for utilization in the present invention. The motorcycle frame of the diagram shows a tubular frame. Frames can be tubular or of other shape. Frames can be made of metals or other materials.

FIG. 2, show a diagram of a typical motorcycle facing to the right.

It is important to note that the frame of the motorcycle depicted in FIG. 2 is larger than the frame depicted in FIG. I and so is the size of the vehicle. This invention also provides that the frame can change in size to accommodate and become housing for batteries. By lowering or moving batteries and their weight to the lower frame, the invention also lowers the center of gravity of the motorcycle. The lowering of the center of gravity also improves the stability and safety of this improved electric motorcycle. This invention also recognizes and incorporates that other power technologies can also be incorporated into the frame.

FIG. 3, shows a diagram of a Harley Davidson Motorcycle, the Vrod. The motorcycle is directed to the right and this line diagram emphasizes the significant frame structure of this model motorcycle.

FIGS. 1, 2, and 3 demonstrate the flexibility of the motorcycle frame to increase in size. The frame size also increases with the size of the motorcycle. These figures also demonstrate a corresponding frame size increase due to increasing vehicle weight as one moves from FIG. 1 to FIG. 2 and then from FIG. 2 to FIG. 3. The present invention uniquely incorporates and claims the frame is increased in diameter or size not responding to weight or strength needs but to respond to the need for storage space, power or electricity. Fuel cell and battery technologies are beneficiaries of the present invention.

FIG. 4, show a typical motor scooter facing left with a side profile. The motor scooter is a key vehicle type for this invention. In the gasoline format this is an extremely popular vehicle. This vehicle type has an interesting frame and windscreen incorporated as part of that frame. The wind screen is a means to attach items to the motorcycle such as but not limited to lithium ion batteries. The batteries could be covered so as to utilize the frame to be a unique housing.

This invention recognizes that only a portion of the frame might be needed for power and that only a portion of the frame might be increased in size to meet the need for a certain size, amount of space or technology.

Currently motorcycle frames are made from the same material throughout, traditionally a form or alloy of steel. The present invention recognizes and incorporates that the frame of the motorcycle can be made from a carbon type material. Uniquely, this invention recognizes and incorporates that the motorcycle frame and a section or a portion of the frame may be made of more than one material. Differing materials can and will enhance application functionality for the motorcycle. By example a portion of the frame could include carbon based components for the storage of a gas such as hydrogen. This invention recognizes that a fuel cell stack or stack of cells could be housed in and innovatively protected by the frame. This invention uniquely uses the frame as housing while the structural integrity of the frame also provides a dual use of protection. This invention also recognizes that the incorporation of a fuel cell within the frame of the motorcycle will provide additional electric power to the motorcycle addressing a number of the shortcomings of battery-powered motorcycles. This benefit of this invention and its claims are extended to motorcycles, motor scooters, motorbikes, and motortrikes or three wheeled motorcycles. Motorcycle as utilized in the present invention is defined to include the following: motorcycles, motorbikes, motor scooters, and motorcycle trikes. Even a fuel cell of only one thousand watts is an improvement in battery motorcycles.

Frame as utilized herein and in the claims is not limited to only the motorcycle frame, but also includes forks and straight or curved tubular runs of pipe. This invention recognizes and incorporates that Springer front ends on a motorcycle have more straight runs on the front of the motorcycle. These straight runs of hollow tubing are utilized by this invention. Typical front ends that have tubular shock absorbers are used.

FIG. 5, shows a turbine and a generator.

This figure illustrates a frame wind turbine and generator that is to be incorporated into the frame component of the motorcycle.

FIG. 6, shows a frame wind turbine and a device resembling a muffler. A muffler like device can be housing for a frame wind generator on a motorcycle. It is understood that a battery powered motor cycle, a fuel cell motorcycle, a fuel cell battery motorcycle would not require a hydrocarbon fuel exhaust component such as a muffler. The device can be housing for one or more frame wind generators or other system and house these systems in a device with the look and appeal of a motorcycle component.

FIG. 7, shows a muffler like device that can be housing for a sound system and the muffler like device can also become a component that can transfer and direct the generated sounds.

This diagram presents a component of a motorcycle that appears to be a muffler with a sound generating system inside the device. The device can be open at both ends or one end. The preferred embodiment would be with the front end closed and the rear open. This embodiment of this invention relates to electric motorcycles which do not need or require a muffler. FIG. 7 is an embodiment of the present invention relates to the inherent property of electric motorcycles which is they are quiet, very quiet. Even certain manufacturers or former manufacturers of battery powered motorcycles have realized they are too quiet. Public comments of some riders are that they are too quiet and the motorcycle has no sound signature at all.

FIG. 8, shows a muffler like device that is a housing for batteries, fuel cells, other technologies or multiple units or multiple technologies.

This figure illustrates that the muffler like device is also a housing for other technologies and is used by multiple technologies simultaneously. The same device also contains multiple units of selected technologies within the same device. This figure illustrates a frame wind generator and a sound generating system within the same muffler like device. This invention is not limited to a muffler like device; the muffler like device is an innovative and unique device in its own right. In order to fully practice this invention, the invention demonstrates the method and process that even an unnecessary and unobvious device like a muffler on a battery powered motorcycle are incorporated as a housing and home for additional and multiple functionality. These new features and technologies increases and improves the technical and commercial viability of product or system, such as a motorcycle. A simulated exhaust pipe is easily the home or housing for the sound generating system and also uniquely doubles as housing for the wind generator or other system while also including a light or horn. Fuel cells or batteries are also incorporated by further example.

The device is not anticipated to provide a front housing for traditional lighting and a front housing for a frame generator at the same time. In addition to the typical motorcycle like sounds, the sound generating system provides additional sounds as well. These sounds are added by memory sticks, Sims cards, computer down load or other means. Multiple sound systems are included. The sound system can produce the sound of a horn. The sound generating system will allows for the removal of the current horn, also removing it as a drag producing component and removing its inherent cost.

The FIGS. 7 and 8 demonstrates the inclusion of technologies to produce electricity and sound. This invention uniquely recognizes that more electricity and noise provides an improvement to the electric motorcycle. This invention further recognizes that providing more power and a noise signature will uniquely increase the acceptance by the public and thereby improve and increase the commercial potential of the electric motorcycle.

This invention uniquely adds an innovative feature to the electric motorcycle. This invention incorporates that a sound generating system be added to the hybrid or fuel cell powered motorcycle. As an example, the throaty tones similar to a Harley Davidson Motorcycle could be recorded or generated and keyed to provide noise to the electric motorcycle. Additionally, the sound generating system will generate engine sounds in response to throttle controls. Although no noise system will make an electric motorcycle instantly into a Harley Davidson Fat Boy or other model or BMW. This innovation brings attention to the electric motorcycle and its rider. Similar to the attention riders of Harley Davidson's enjoy. The embodiment of the present invention is for motorcycles and need only address sound for start up, idle and forward motion. Since certain hybrid electric, electric, battery and fuel cell motorcycles will have no internal combustion engine noise and not provide that noise signature.

This invention and its claims are not limited to gasoline, battery, or fuel cell motorcycles. This invention incorporates and claims hybrid motorcycles as well and is not limited by fuel type, such as gasoline or hydrogen as used in the present invention. Products as claimed by the present invention include but are not limited to fuels, gasoline, hydrogen, batteries, capacitors, battery systems, fuel cells, fuel cell stacks, fuel cell balance of plant as well as supporting and connection systems.

The present invention recognizes and incorporates that this invention is the keystone to return the electric motorcycle to commercial viability, for the development of the hybrid motorcycle and importantly the fuel cell motorcycle. Hybrid motorcycles as envisioned by this invention will desire to have regenerative breaking as do hybrid automobiles. The energy to be stored from such regenerative breaking requires a storage media, such as batteries or even capacitors. The present invention provides a space and housing for the energy storage media.

The present invention is key for the development of the fuel cell motorcycle, and the hybrid fuel cell. The hybrid fuel cell motorcycle will need to store significant electricity, this invention provides, space and housing for such storage. Fuel cell motorcycles by this invention will utilize batteries or capacitors in conjunction with fuel cells. This has the distinct advantage of reducing the power requirements necessary from fuel cells and will thereby reduce their cost and hasten their initial commercial introduction.

### Singificance of the Invention

The significance of this invention involves providing and teaching the processes, methods and apparatus to enhance and make electric motorcycles a more functionally viable, more workable and commercial system and includes the following:

A. This invention has developed methods and processes to innovatively identify and develop dual uses for components of the motorcycle, especially the battery motorcycle.

B. This invention allows the frame of the motorcycle not only be a frame but to also simultaneously provide a housing for batteries, capacitors and fuel cell stacks and systems. As an example, this invention allows more batteries to be added to a battery-powered motorcycle without requiring more space for the batteries. The invention's dual use of the frame provides a housing for the batteries that uniquely adds little or no extra weight and requires no additional room for this housing.

C. This invention allows the frame to simultaneously be a frame and housing but additionally utilizes the frame as a substantial and protective structure.

Frames of many motorcycles are substantial structures. This invention incorporates the frame into a protective enclosure. This protective enclosure adds no weight, requires no additional space and can utilize such innovative and beneficial technologies as fuel cells. The frame is also the protective structure for fuel cells and the frames can also be pressurized.

D. This invention is applicable to other motorcycle types including gasoline, electric, fuel cell, or hybrid powered motorcycle.

E. This innovation brings commercial viability to battery powered motorcycles by viably adding more batteries thereby directly extending their range.

F. This innovation also increases space for additional batteries and thereby increases the power available to the motorcycle. The present invention increases the load carrying capacity of electric motorcycles increasing their desirability to the general public.

G. This invention is extended to other motorcycle types including motorcycles, motor scooters, motorcycle trikes and motor bikes.

H. This invention accommodates a wide variety of technologies. Batteries of varying technologies, fuel cells and hybrid technologies are examples of technologies that will be able to be incorporated and become beneficiaries of this invention.

I. This invention modifies and improves an electric motorcycle and help to bring back to commercialization an improved electric motorcycle. This motorcycle improved by the present invention will be economical, commercially viable and can be purchased by many worldwide as compared to four wheel passenger vehicles.

J. This invention makes possible the worldwide distribution of an environmentally clean, more affordable motorcycle for public transportation. This innovation will help to lower pollution. The present invention will allow the electric motorcycle to have more batteries, therefore use more off peak electricity to charge the batteries, and thereby displace more fossil fuels.

K. This invention increases the electric power of motorcycles and allows for designers to have more freedom to make electric motorcycles larger and with more model types, such as cruisers.

L. This invention by its electric nature is focused to reduce the amount of imported oil.

M. This invention is a key invention for the development of a hybrid electric motorcycle. Space for energy storage is provided.

This invention is a key invention for the development of a fuel cell motorcycle. This invention will improve the commercial viability and early introduction of the fuel cell powered motorcycle.

1. Apparatus for affixing batteries to a motorcycle for the production of electricity, comprising:
a) a battery or plurality of batteries sized to fit within the frame of a motorcycle;
b) motorcycle frame of sufficient size or diameter to fit and contain the batteries;
c) means for connecting the batteries to the motorcycle electric connection, bus or battery system.

2. Apparatus in accordance with claim 1, further including a grounding connection for the batteries.

3. Apparatus in accordance with claim 1, further including a connection the battery system to a voltage regulator.

4. A method of identifying structures on a motorcycle or other motorcycle to be utilized for an additional purpose, comprising the steps of:
a) identifying a need,
b) identifying a structure to be utilized to address the need,
c) identifying a product that fulfills the need and can be accommodated by the structure.

5. A method in accordance with claim 4, further identifying a structure that is hollow such as a frame to be utilized for a product for the benefit of the motorcycles or other motorcycle's commercial viability.

6. A method in accordance with claim 4, further identifying a structure and a product to affix to or on for the benefit of the motorcycle's commercial viability.

7. Apparatus for containing fuel for the motorcycle to supply the fuel to the motorcycle, comprising;
a) a frame or container within the frame to hold a fuel,
b) a fuel such as but not limited to gasoline or hydrogen,
c) a line to connect the fuel to the fuel system.

8. Apparatus in accordance with claim 7, including a fuel monitoring device.

9. Apparatus in accordance with claim 7, including a fuel regulating device.

10. Apparatus in accordance with claim 7, including a fuel pumping device.

11. A method of protecting a product by installing or placing it within the frame of a motorcycle.

12. A method of protecting a product by installing or placing it within a saddle bag like housing.

13. A method for incorporating a wind driven generator within a motorcycle, comprising the use of an opening within the frame to install the generator and an opening to allow the resulting air flow to escape.

14. A method in accordance with claim 13, further including the step of connecting an electric line to allow for the flow of electricity from the generator.

15. A method in accordance with claim 14 for the electric line to be connected to the electric system of the motorcycle.

16. Apparatus to contain one or more systems for a motorcycle, comprising;
a) a housing resembling an exhaust pipe of a motorcycle,
b) a system or systems to be installed in or on the resembled pipe.

17. Apparatus in accordance with claim 16, including an electronic sound generating system.

18. Apparatus in accordance with claim 16, including a wind generator within the resembled pipe.

19. A method of adding safety and amusement to an electric motorcycle by adding sounds, comprising the steps of:
a) identifying the sounds to be added,
b) adding the sounds to a recording media,
c) installing a playback device,
d) connecting the play back device to an electric or other power source.

20. Method in accordance with claim 19, further including adding a switch or other means to turn on or off the apparatus.

21. A method in accordance with claim 19 of providing a selector switch or other means to select the sound to be made.

22. A method in accordance with claim 19, further connecting the playback device to throttle selector or other means to modify the sound volume produced to movement of the throttle selector, rheostat or other means.

23. Apparatus for containing fuel for the fuel cell motorcycle to supply the fuel to the motorcycle, comprising;
a) a frame or container within the frame to hold a fuel,
b) a fuel such as but not limited to hydrogen or a hydrogen storage media,
c) a line to connect the fuel to the fuel cell system.

24. Apparatus in accordance with claim 23, including a fuel and pressure monitoring device.

25. Apparatus in accordance with claim 23, including a fuel regulating device.

26. Apparatus in accordance with claim 23, including a fuel manifold and pumping device.

27. A method of protecting a fuel cell stack by installing it within the frame of a motorcycle.

28. A method of protecting a fuel cell balance of plant by installing it within the frame of a motorcycle.
